(19) United States
(12) Patent Application Publication
(10) Pub. No.: US 2025/0030480 A1
(43) Pub. Date: Jan. 23, 2025

(54) OPTICAL PATH DESIGN APPARATUS, OPTICAL PATH DESIGN METHOD AND PROGRAM

(71) Applicant: NIPPON TELEGRAPH AND TELEPHONE CORPORATION, Tokyo (JP)

(72) Inventors: Hanami YOKOI, Tokyo (JP); Kojun KOSHIJI, Tokyo (JP); Shingo OKADA, Tokyo (JP); Yasuharu KANEKO, Tokyo (JP); Tatsuya MATSUKAWA, Tokyo (JP); Takashi MIYAMURA, Tokyo (JP)

(73) Assignee: NIPPON TELEGRAPH AND TELEPHONE CORPORATION, Tokyo (JP)

(21) Appl. No.: 18/709,480

(22) PCT Filed: Nov. 15, 2021
(86) PCT No.: PCT/JP2021/041965

§ 371 Date: May 10, 2024

(51) Int. Cl. H04B 10/07; H04B 10/27

(52) U.S. Cl. CPC H04B 10/07; H04B 10/27

(57) ABSTRACT

Provided is an optical path design device which includes a transmission quality calculation unit which estimates transmission quality of a plurality of candidate routes in an optical transmission network; and a route selection unit which selects a candidate route that satisfies the transmission quality from the plurality of candidate routes.

### TECHNICAL FIELD

The present invention relates to an optical path design device, an optical path design method, and a program.

### BACKGROUND ART

In an optical transmission network, communication data is handled by light, and communication demand present in the optical transmission network is called an optical path. In order to improve the accommodation efficiency of the optical path, a wavelength allocation method and a route calculation method of the optical path are being studied. At this time, in order to accurately transmit the information converted into light at a start node to an end node, it is necessary to calculate the route in consideration of the transmission quality of the optical path.

As a related art, a method for considering transmission quality at the time of route calculation has been proposed (NPL 1). In the related art, a combination of a route and a wavelength having a small optical signal to noise ratio (OSNR) is selected for a given modulation method.

### CITATION LIST

### Non Patent Literature

[NPL 1] R. Cardillo, V. Curri, M. Mellia, “Considering transmission impairments in configuring wavelength routed optical networks,'” in Proc. OFC/NFOEC 2006, Anaheim, CA, USA, March 2006.

### SUMMARY OF INVENTION

### Technical Problem

In the related art, since the modulation method is fixed, if the transmission quality required for the optical path cannot be satisfied by the given modulation method, there is a problem that the optical path cannot be set. At this time, although there are cases where the optical path can be set by passing through a regenerative repeater (a device for eliminating attenuation and deterioration of an optical signal by OEO conversion) along the route of the optical path, an increase in the cost of the optical path due to the use of an expensive regenerative repeater is a problem. Further, in an optical transmission network in practical use, since there are few nodes in which the regenerative repeater is installed, a case where the transmission distance increases due to passing through the regenerative repeater is considered.

An object of the disclosed technique is to realize an optical path design in which a modulation method can be changed in accordance with transmission quality.

### Solution to Problem

The disclosed technique is an optical path design device including: a transmission quality calculation unit which estimates transmission quality of a plurality of candidate routes in an optical transmission network; and a route selection unit which selects a candidate route that satisfies the transmission quality from the plurality of candidate routes.

### Advantageous Effects of Invention

Optical path design in which a modulation method can be changed depending on transmission quality can be realized.

### BRIEF DESCRIPTION OF DRAWINGS

FIG. 1 is a diagram showing a functional structural example of an optical path design device.

FIG. 2 is a flowchart showing an example of the flow of optical path design processing.

FIG. 3 is a diagram showing an example of an optical transmission network.

FIG. 4 is a diagram showing an example of a topology information DB.

FIG. 5 is a diagram showing an example of a wavelength information DB.

FIG. 6 is a diagram showing an example of an optical path information DB.

FIG. 7 is a diagram showing an example of a device information DB.

FIG. 8 is a diagram showing an example of a candidate route information DB.

FIG. 9 is a diagram showing an example of an optical path information DB according to the embodiment.

FIG. 10 is a first diagram showing an example of a candidate route information DB according to the embodiment.

FIG. 11 is a diagram showing an example of a device information DB according to the embodiment.

FIG. 12 is a second diagram showing an example of candidate route information DB according to the embodiment.

FIG. 13 is a third diagram showing an example of candidate route information DB according to the embodiment.

FIG. 14 is a fourth diagram showing an example of candidate route information DB according to the embodiment.

FIG. 15 is a fifth diagram showing an example of candidate route information DB according to the embodiment.

FIG. 16 is a diagram showing an example of a wavelength information DB according to the embodiment.

FIG. 17 is a sixth diagram showing an example of candidate route information DB according to the embodiment.

FIG. 18 is a diagram showing a hardware configuration example of a computer.

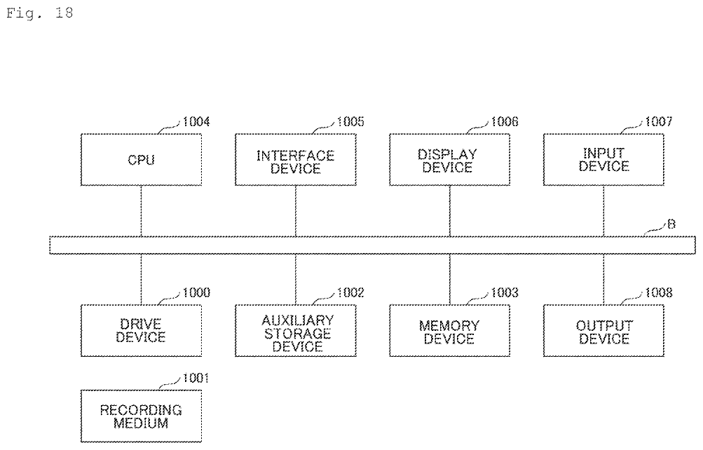

### DESCRIPTION OF EMBODIMENTS

An embodiment of the present invention (present embodiment) will be described below with reference to the drawings. Embodiments which will be described later are merely examples and embodiments to which the present invention is applied are not limited to the following embodiments.

### (Overview of Embodiment)

The optical path design device according to the present embodiment is a device which designs an optical path in an optical transmission network, and performs a route search in the optical path design in consideration of the transmission quality of the route and the modulation mode used in the route at the time of route search.

Reference numbers and document names related to the reference technology or the like of the present embodiment are collectively described at the end of the present embodiment. In the following description, numbers of related references are shown as “[1]” and the like.

### (Functional Configuration Example of Optical Path Design Device)

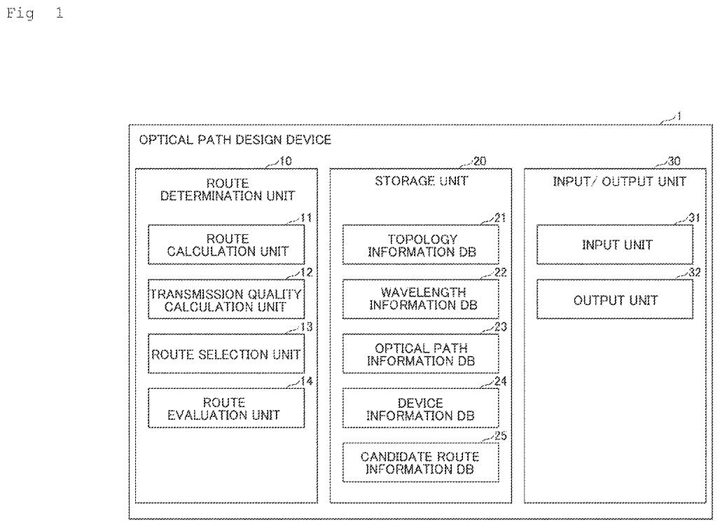

FIG. 1 is a diagram showing an example of a functional configuration of an optical path design device. The optical path design device 1 includes a route determination unit 10, a storage unit 20, and an input/output unit 30.

The route determination unit 10 includes a route calculation unit 11, a transmission quality calculation unit 12, a route selection unit 13, and a route evaluation unit 14.

The route calculation unit 11 derives a route on the basis of information stored in a topology information DB 21 and a wavelength information DB 22 to be described later. The transmission quality calculation unit 12 calculates the transmission quality of the route on the basis of information stored in the topology information DB 21 to be described later.

The route selection unit 13 determines a candidate route on the basis of a transmission distance of the route and a transmission quality value stored in the transmission quality DB. The route evaluation unit 14 evaluates the candidate route determined by the route selection unit 13, determines one route or ranks priority of the route.

The storage unit 20 includes a topology information DB 21, a wavelength information DB 22, an optical path information DB 23, a device information DB 24, and a candidate route information DB 25.

The topology information DB 21 is a database that stores topology information. The topology information is information indicating a connection relationship between nodes and links in an optical transmission network, a distance between nodes, and the like.

The wavelength information DB 22 is a database that stores wavelength information. The wavelength information is information indicating a utilization situation of a wavelength in each link of the optical transmission network.

The optical path information DB 23 is a database for storing the optical path information. The optical path information is information indicating a request condition of an optical path which is set in the optical transmission network.

The device information DB 24 is a database that stores device information. The device information is information indicating a modulation method, loss, and the like of a device in the optical transmission network.

The candidate route information DB 25 is a database that stores candidate route information. The candidate route information DB 25 is information indicating the candidate route derived by the route calculation unit 11, the transmission quality derived by the transmission quality calculation unit 12 for the candidate route, and the like.

The input/output unit 30 includes an input unit 31 and an output unit 32. The input unit 31 receives information such as topology information, wavelength information, optical path information, and device information. The output unit 32 outputs route information indicating the route determined by the route determination unit 10.

### (Operation of Optical Path Design Device)

Next, an operation of the optical path design device 1 will be described with reference to the accompanying drawings. Here, the flow of the entire processing will be mainly described, and the details of each process will be described later.

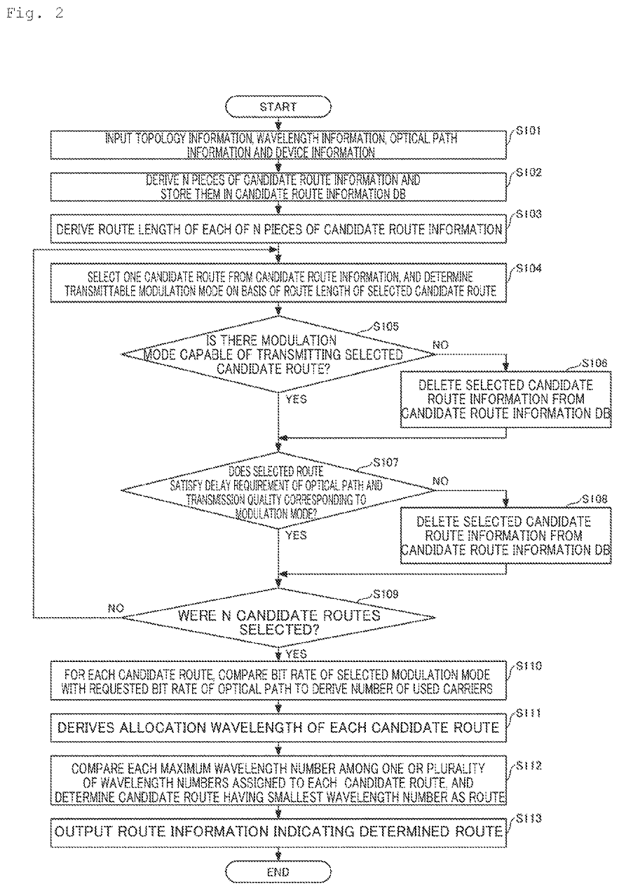

FIG. 2 is a flowchart showing an example of a flow of optical path design processing. In a preparation stage, the input unit 31 receives topology information, wavelength information, optical path information, and device information through a user operation, a transmission from an external device or the like (step S101).

Next, the route calculation unit 11 derives N pieces of candidate route information and stores them in a candidate route information DB 25 (step S102). The route calculation unit 11 derives each route length of the N pieces of candidate route information (step S103).

Next, the transmission quality calculation unit 12 selects one candidate route from the candidate route information, and determines a transmittable modulation mode on the basis of the route length of the selected candidate route (step S104).

The route selection unit 13 determines whether there is a modulation mode in which transmission along the selected candidate route is possible (step S105). When it is determined that there is no modulation mode in which transmission along the selected candidate route is possible (step S105: No), the route selection unit 13 deletes the selected candidate route information from the candidate route information DB (step S106).

When it is determined that there is a modulation mode in which transmission along the selected candidate route is possible (step S105: Yes), the route selection unit 13 skips the processing of step S106.

The route selection unit 13 determines whether the selected route satisfies the delay requirement of the optical path and transmission quality corresponding to the modulation mode (step S107). When it is determined that the selected route does not satisfy the delay requirement of the optical path and the transmission quality corresponding to the modulation mode (step S107: No), the route selection unit 13 deletes the selected candidate route information from the candidate route information DB (step S108).

When the route selection unit 13 determines that the selected route satisfies the delay requirement of the optical path and the transmission quality corresponding to the modulation mode (step S107: Yes), the route selection unit 13 skips the processing of step S108.

The route selection unit 13 determines whether N candidate routes are selected (step S109). When it is determined that N candidate routes are not selected (step S109: No), the route selection unit 13 returns to the processing of step S104 and selects the next candidate route.

When it is determined that the route selection unit 13 has selected N candidate routes (step S109: Yes), the route evaluation unit 14 compares the bit rate of the selected modulation mode and the required bit rate of the optical path for each candidate route, and derives the number of used carriers (step S110).

Then, the route evaluation unit 14 derives an allocation wavelength of each candidate route (step S111). The route evaluation unit 14 compares the respective maximum wavelength numbers among one or a plurality of wavelength numbers allocated to the respective candidate routes, and determines a candidate route having the smallest wavelength number as a route (step S112).

The route determination method in the processing of step S112 is a determination method for equalizing the utilization rate of the wavelength of each route in the optical transmission network, but may be another determination method. Also, the output unit 32 outputs the route information indicating the determined route (step S113). The route information thus output is information indicating a route in which the transmission quality of the optical path is taken into consideration.

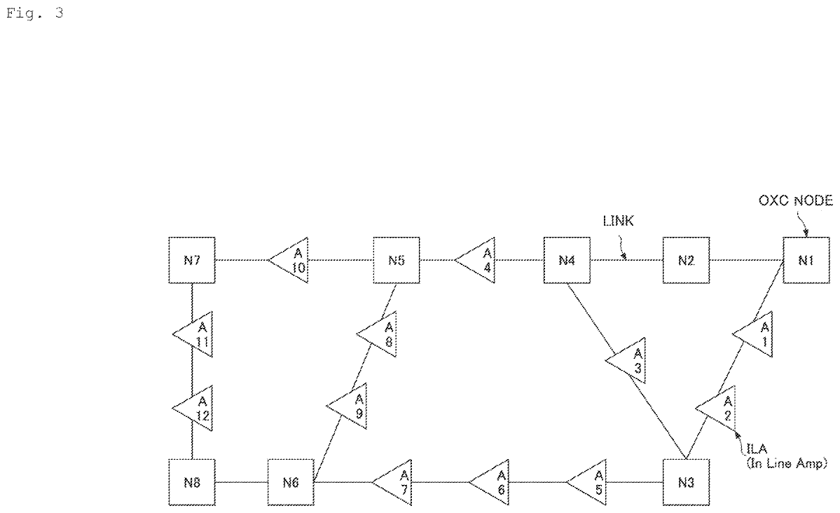

FIG. 3 is a diagram showing an example of an optical transmission network. The optical transmission network shown in FIG. 3 includes a plurality of OXC (Optical Cross Connect) nodes and links between the respective OXC nodes. Each link may include one or multiple In Line Amps (ILA). The optical path design device 1 designs, for example, an optical path in the optical transmission network shown in FIG. 3.

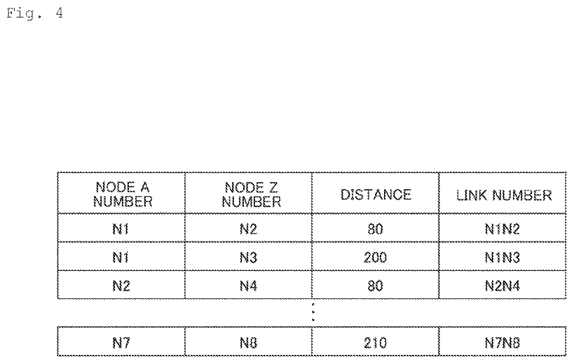

FIG. 4 is a diagram showing an example of a topology information DB. The topology information shown in FIG. 4 is information showing a positional relationship of the optical transmission network shown in FIG. 3. Specifically, the topology information includes a number for identifying OXC nodes at both ends of each link, a distance of each link, a number for identifying each link, and the like.

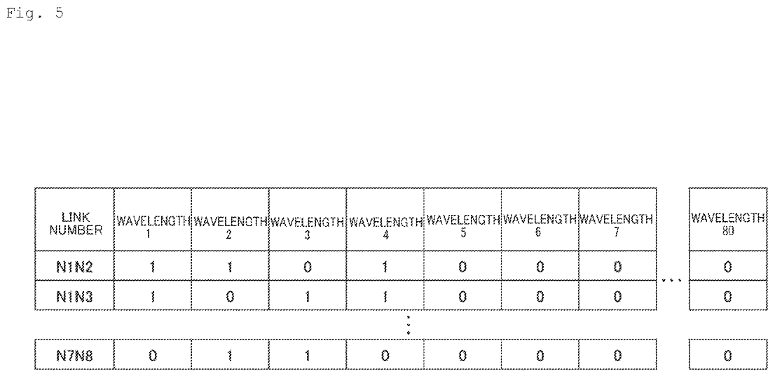

FIG. 5 is a diagram showing an example of the wavelength information DB. The wavelength information shown in FIG. 5 is information indicating the number of the wavelength used by each link. In FIG. 5, one of a value (1) indicating that the device is in use and a value (0) indicating that the device is not in use is set for number of each wavelength. The wavelength numbers are associated with respective specific wavelengths in advance. For example, a smaller wavelength number may be associated with a smaller wavelength, but the present invention is not limited thereto.

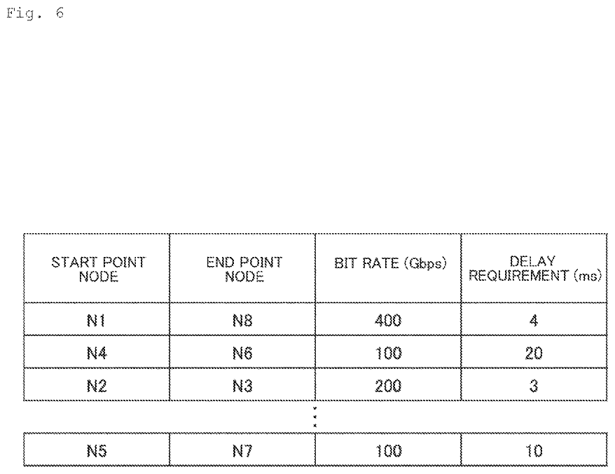

FIG. 6 is a diagram showing an example of the optical path information DB. The optical path information shown in FIG. 6 is information indicating a request condition of an optical path set in the optical transmission network. As for the optical path information, a bit rate, a delay requirement and the like as an example of a request condition are set for each combination of a start point and an end point of an optical path to be designed. The items of the optical path information DB may be added when the setting request of the optical path arrives.

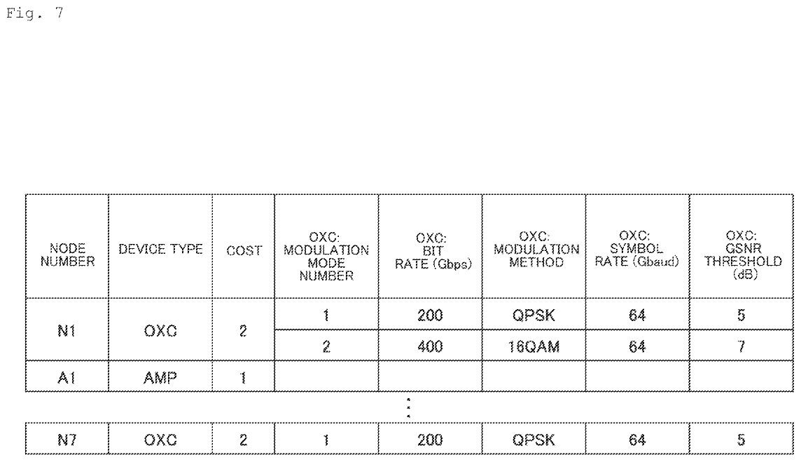

FIG. 7 is a diagram showing an example of the device information DB. The device information shown in FIG. 7 includes a device type (OXC or ILA) for realizing the function of each OXC node, a cost generated via the device, a number for identifying a modulation mode settable by a transponder of each OXC, a bit rate in each modulation mode, a modulation method, a symbol rate, a GSNR threshold, and the like.

A number indicating a modulation mode that can be realized, a bit rate, a modulation method, a symbol rate, a GSNR threshold and the like in each modulation mode are set, when the type of the device is OXC.

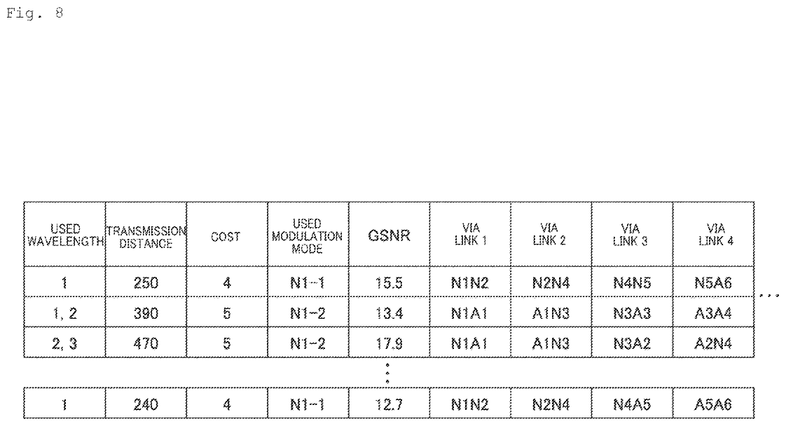

FIG. 8 is a diagram showing an example of the candidate route information DB. The candidate route information shown in FIG. 8 is information indicating the candidate route derived by the route calculation unit 11. The candidate route information includes, as items, a used wavelength, a transmission distance, a cost, a used modulation mode, a GSNR, a via link, and the like.

The value of the item “used wavelength” is a value indicating the wavelength used in the candidate route. The value of the item “transmission distance” is a value indicating the transmission distance of the candidate route. The value of the item “cost” is a total value of the costs related to the device via which the candidate route passes.

The value of the item “used modulation mode” is a value indicating a modulation mode used in the candidate route, and is, for example, a value in the form of (node name-modulation mode number). The value of the item “GSNR” is a value indicating the quality of the transmission route derived by the transmission quality calculation unit 12. The value of the item “via link” is one or multiple links used in the route.

### SPECIFIC EMBODIMENT

A specific embodiment of the present embodiment will be described below, and the details of the above-described each processing will be further described.

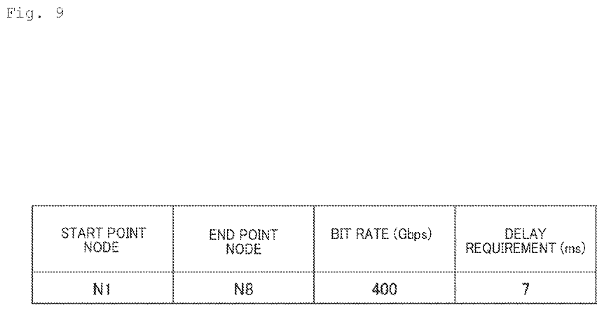

FIG. 9 is a diagram showing an example of an optical path information DB according to the embodiment. The input unit 31 inputs, for example, optical path information shown in FIG. 9 in the processing of the step S101 of FIG. 2. Here, the input unit 31 may input topology information, wavelength information, device information, and the like in advance.

The route calculation unit 11 refers to a combination of a start point node and an end point node of the optical path and a requested bit rate from the optical path information. Then, the route calculation unit 11 derives a plurality of candidate routes reaching from the start point node to the end point node, and stores the candidate route information indicating the derived candidate routes in the candidate route information DB 25.

In the present embodiment, the route calculation unit 11 searches for a route of an optical path to be transmitted from N1 to N8 at 400 Gbps.

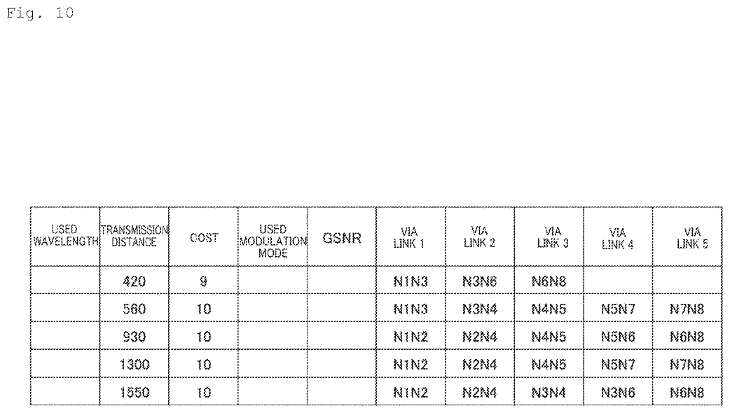

FIG. 10 is a first diagram showing an example of the candidate route information DB according to the embodiment. In the processing of step S102 of FIG. 2, the route calculation unit 11 derives a candidate route of the optical path to be transmitted from a start point node N1 to an end point node N8. The route calculation unit 11 may derive K shortest paths, using K-shortest path [1] as the derivation method of the candidate route. The derivation method of the candidate route is not limited thereto. In the present embodiment, the route calculation unit 11 derives five shortest paths by the K-shortest path algorithm [1] of K=5, and stores the candidate route information as shown in FIG. 10 in the candidate route information DB 25.

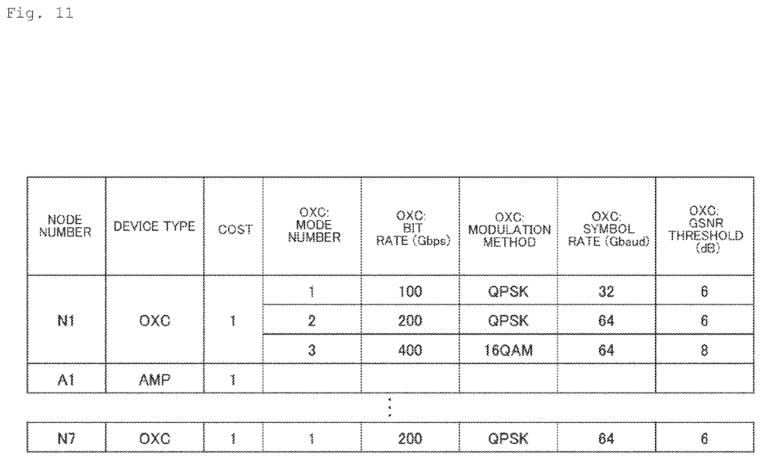

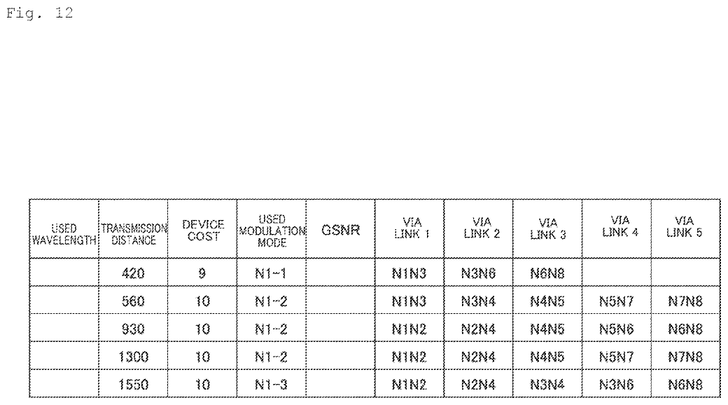

The route selection unit 13 determines a modulation mode in which the candidate route can be transmitted in step S104 from the route length for each candidate route derived in the step S103 of FIG. 2. FIG. 11 is a diagram showing an example of the device information DB according to the embodiment. FIG. 12 is a second diagram showing an example of the candidate route information DB according to the embodiment.

When the route selection unit 13 determines the modulation mode of each candidate route with reference to the device information DB shown in FIG. 11, the route selection unit 13 updates the candidate route information stored in the candidate route information DB as shown in FIG. 12.

Then, the route selection unit 13 deletes the candidate route information in which there is no modulation mode transmittable by the processing of the step S106, from the candidate route information DB.

Here, the transmission quality calculation unit 12 estimates the transmission time of each candidate route. For example, the transmission quality calculation unit 12 calculates the transmission time of the route by the transmission distance/the propagation speed of the signal in the optical fiber. In the present embodiment, the transmission quality calculation unit 12 derives the transmission time, as the propagation speed of the signal in the optical fiber=200,000 (km/s).

Further, in processing of step S107 in FIG. 2, the route selection unit 13 determines whether the candidate route satisfies delay requirements required for the optical path. In the present embodiment, the route selection unit 13 determines that the delay requirement of the optical path is 7 ms from the optical path information shown in FIG. 9. Therefore, the route selection unit 13 compares the transmission time with the delay requirements from the transmission distance of each candidate route shown in FIG. 12, and deletes the candidate route information indicating a route (fifth entry of the candidate route information DB shown in FIG. 12) which does not satisfy the delay requirements from the candidate route information DB.

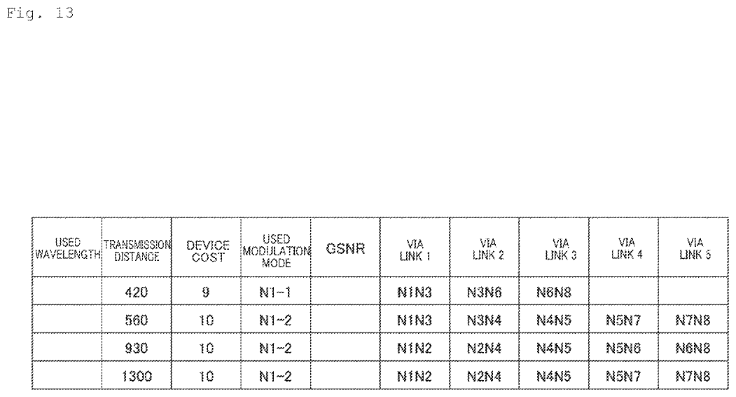

FIG. 13 is a third diagram showing an example of candidate route information DB according to the present embodiment. FIG. 13 shows the candidate route information DB in a state in which a route which does not satisfy the delay requirement is deleted in the present embodiment.

In the processing of step S107 in FIG. 2, the transmission quality calculation unit 12 estimates the transmission quality of each candidate route stored in the candidate route information DB, and updates the candidate route information stored in the candidate route information DB.

Specifically, the transmission quality calculation unit 12 may adopt any of the following estimation methods.

In a first estimation method, the transmission quality calculation unit 12 may actually measure transmission quality of each device, an optical fiber or the like in advance, and may estimate the transmission quality of the entire candidate route, using that stored in the database.

In a second estimation method, the transmission quality calculation unit 12 may estimate the transmission quality of the candidate route, using an OSS library (GNPy [2] or the like) capable of estimating the transmission quality.

In a third estimation method, the transmission quality calculation unit 12 may actually set an optical path using the candidate route in an optical transmission network and actually measure transmission quality.

The method of estimating the transmission quality is not limited to any of the above-mentioned methods, and other methods may be used.

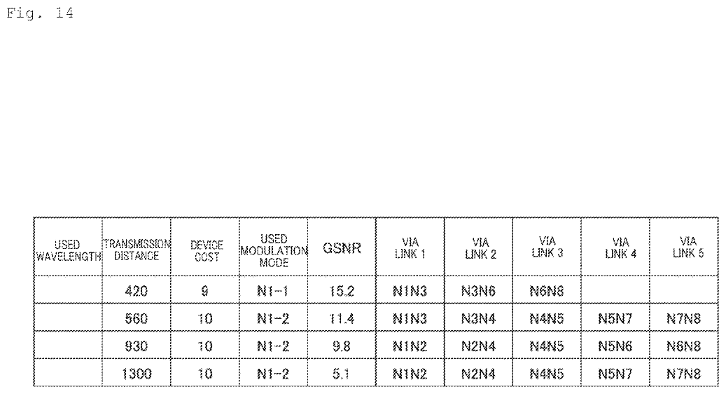

FIG. 14 is a fourth diagram showing an example of candidate route information DB according to the present embodiment. FIG. 14 shows the candidate route information DB in a state in which the value of the item “GSNR” is updated as a value indicating the estimated transmission quality.

The route selection unit 13 determines whether the candidate route satisfies transmission quality for modulation of the optical path. Specifically, the route evaluation unit 14 compares a threshold of GSNR for a modulation mode of each candidate route with transmission quality of each candidate route to determine whether the transmission quality is satisfied.

Then, the route selection unit 13 deletes candidate route information indicating a route which does not satisfy the quality, from the candidate route information DB in the processing of the step S108 of FIG. 2. In the present embodiment, the route selection unit 13 deletes candidate route information indicating a route (fourth entry of the candidate route information DB shown in FIG. 14) which does not satisfy the transmission quality from the candidate route information DB.

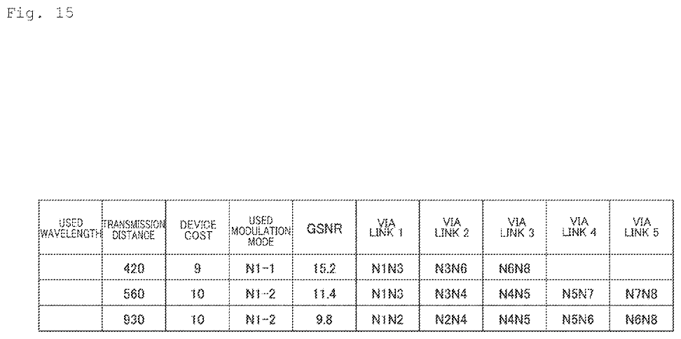

FIG. 15 is a fifth diagram showing an example of candidate route information DB according to the present embodiment. FIG. 15 shows candidate route information DB in the state in which a route which does not satisfy the transmission quality is deleted in the present embodiment.

The route evaluation unit 14 derives the number of used carriers in step S110 of FIG. 2. Specifically, the route evaluation unit 14 derives the number of used carriers, by comparing the bit rate of the selected modulation mode with the requested bit rate of the optical path to derive the number of used carriers.

For example, in the candidate route information of the first entry of the candidate route information DB shown in FIG. 15, since the modulation mode 1 of 400 Gbps is selected, the number of used carriers is 1. On the other hand, in the candidate route information of the second entry and the third entry, since the modulation mode 2 of 200 Gbps is selected, the number of used carriers is 2.

Then, the route evaluation unit 14 derives an allocation wavelength in step S111 of FIG. 2. Specifically, the route evaluation unit 14 acquires information indicating a wavelength already used from the wavelength information DB.

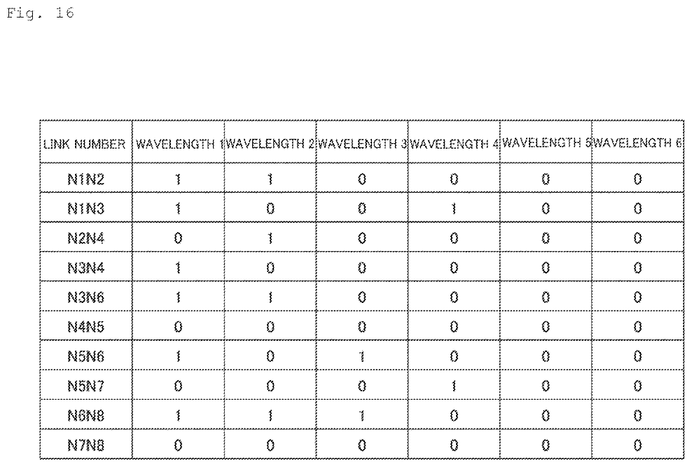

FIG. 16 is a diagram showing an example of a wavelength information DB according to the present embodiment. FIG. 16 shows information indicating wavelengths already used in the present embodiment. The route evaluation unit 14 may derive an allocation wavelength for each candidate route according to a first-Fit wavelength allocation. The first-fit wavelength allocation is a method of allocating the shortest wavelength among usable wavelengths.

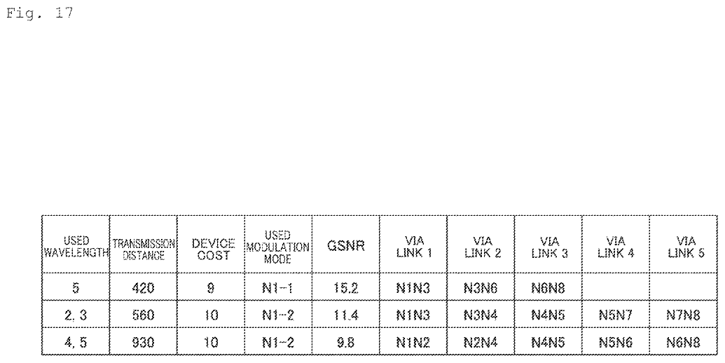

FIG. 17 is a sixth diagram showing an example of candidate route information DB according to the present embodiment. FIG. 15 shows candidate route information DB in the state in which the used wavelength is allocated by first-fit wavelength allocation in the present embodiment.

The route evaluation unit 14 evaluates each candidate route in the candidate route information DB shown in FIG. 17, and determines the route of the optical path. In the present embodiment, the route evaluation unit 14 compares the maximum wavelength numbers of the assigned wavelengths of the candidate routes and selects a route having the smallest maximum wavelength number. For example, the candidate route information of the second entry of the candidate route information DB shown in FIG. 17 is determined as the route of the optical path because the smallest maximum wavelength number 3 is allocated.

(Hardware Configuration Example According to Present Embodiment) The optical path design device 1 can be implemented, for example, by causing a computer to execute a program that describes the processing details described in the present embodiment. Note that the “computer” may be a physical machine or a virtual machine in the cloud. When using a virtual machine, the “hardware” described here is virtual hardware.

The program can be stored and distributed by being recorded in a computer-readable recording medium (portable memory or the like). In addition, the above program can also be provided through a network such as the Internet or e-mail.

FIG. 11 is a diagram showing a hardware configuration example of the computer. The computer shown in FIG. 11 includes a drive device 1000, an auxiliary storage device 1002, a memory device 1003, a CPU 1004, an interface device 1005, a display device 1006, an input device 1007, an output device 1008, and the like which are connected to each other via a bus B, respectively.

A program for realizing processing in the computer is provided by a recording medium 1001 such as, for example, a CD-ROM or a memory card. When the recording medium 1001 having a program stored therein is set in the drive device 1000, the program is installed from the recording medium 1001 through the drive device 1000 to the auxiliary storage device 1002. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes a function relevant to the device in accordance with the program stored in the memory device 1003. The interface device 1005 is used as an interface for connection to a network. The display device 1006 displays a graphical user interface (GUI) and the like according to the program. The input device 1007 is constituted by a keyboard, a mouse, a button, a touch panel, or the like, and is used for inputting various operation instructions. The output device 1008 outputs a calculation result. The computer may include a graphics processing unit (GPU) or a tensor processing unit (TPU) instead of the CPU 1004, or may include a GPU or a TPU in addition to the CPU 1004. In that case, for example, processing may be divided and executed in such a way that the GPU or the TPU executes processing that requires special arithmetic operations, and that the CPU 1004 executes other processing.

(Effect of Present Embodiment) The optical path design device 1 according to the present embodiment will be described. Thus, the optical path design capable of changing the modulation method according to the transmission quality can be realized.
More specifically, the following effects can be obtained for a network operator who provides an optical transmission network.
Since the wavelength utilization factor in the optical transmission network can be made uniform, it is possible to delay the timing required for the installation extension when the same number of optical paths are allocated.
Since the number of options of modulation modes applicable to the route calculation increases, it is possible to propose a route that does not pass through the regenerative repeater. Thus, it is possible to shorten the transmission distance, and to reduce the cost of the equipment and the wavelength resource. This is particularly effective when the bit rate of the optical path is large or when the transmission distance is long.
By calculating candidate routes for each modulation mode, it is possible to derive routes along the conditions (transmittable distance and allowable loss) for each modulation mode.
By periodically updating the device information by means of actual measurement or the like, it is possible to avoid a deteriorated portion of the transmission quality due to a failure of the device or deterioration of the link, and to select a route having a constant quality.

Further, the following effects can be obtained for a network user who uses an optical transmission network.
The optical path satisfying the required delay requirements can be utilized.
Because the network operator utilizes the optical path design device 1 according to the present embodiment and the device cost decreases, it is possible to expect the reduction of the network utilization cost, the expansion of other services and the like.

### REFERENCES

[1] Jin Y. Yen, “Finding the K Shortest Loopless Paths in a Network,'” Management Science, vol. 17, no. 11, July 1971.
[2] Telecom Infra Project—OOPT PSE Group, “gnpy Documentation,'” Sep. 2021.

### SUMMARY OF EMBODIMENTS This specification describes at least an optical path design device, an optical path design method, and a program described in the following items.

### (Item 1)

An optical path design device including:

a transmission quality calculation unit which estimates transmission quality of a plurality of candidate routes in an optical transmission network; and

a route selection unit which selects a candidate route that satisfies the transmission quality from the plurality of candidate routes.

### (Item 2)

The optical path design device according to item 1, in which the route selection unit selects a candidate route having a modulation mode that can be transmitted with respect to a route length of each candidate route included in the plurality of candidate routes, on the basis of information indicating a modulation mode that is usable by a device constituting the optical transmission network.

### (Item 3)

The optical path design device according to item 1 or 2, in which the transmission quality calculation unit estimates transmission times of the plurality of candidate routes, and the route selection unit selects a candidate route satisfying a required delay requirement from the plurality of candidate routes, on the basis of the estimated transmission time.

### (Item 4)

The optical path design device according to any one of items 1 to 3, further including a route evaluation unit which determines a route for uniformizing a utilization rate of a wavelength from the plurality of candidate routes selected by the route selection unit, on the basis of information indicating a utilization situation of the wavelength of each route.

### (Item 5)

The optical path design device according to any one of items 1 to 4, further including:
a route calculation unit which derives a plurality of candidate routes, on the basis of information indicating a positional relationship of the optical transmission network and information indicating a request condition of an optical path,
in which the transmission quality calculation unit estimates the transmission quality of the plurality of candidate routes derived by the route calculation unit.

### (Item 6)

An optical path design method executed by a computer, the method including:
a step of estimating transmission quality of a plurality of candidate routes in an optical transmission network; and a step of selecting a candidate route satisfying the transmission quality from the plurality of candidate routes.

### (Item 7)

A program for causing a computer to function as each unit of the optical path design device according to any one of items 1 to 5.

Although these embodiments have been described above, the present invention is not limited to such specific embodiments and various modifications and changes are possible within the scope of the gist of the present invention described in the claims.

### REFERENCE SIGNS LIST

1 Optical path design device
10 Route determination unit
11 Route calculation unit
12 Transmission quality calculation unit
13 Route selection unit
14 Route evaluation unit
20 Storage unit
21 Topology information DB
22 Wavelength information DB
23 Optical path information DB
24 Device information DB
25 Candidate route information DB
30 Input/output unit
31 Input unit
32 Output unit
1000 Drive device
1001 Recording medium
1002 Auxiliary storage device
1003 Memory device
1004 CPU
1005 Interface device
1006 Display device
1007 Input device
1008 Output device

1. An optical path design device comprising:
a transmission quality calculation unit which estimates transmission quality of a plurality of candidate routes in an optical transmission network; and
a route selection unit which selects a candidate route that satisfies the transmission quality from the plurality of candidate routes.

2. The optical path design device according to claim 1,
wherein the route selection unit selects a candidate route having a modulation mode that can be transmitted with respect to a route length of each candidate route included in the plurality of candidate routes on the basis of information indicating a modulation mode that is usable by a device constituting the optical transmission network.

3. The optical path design device according to claim 1,
wherein the transmission quality calculation unit estimates transmission times of the plurality of candidate routes, and
the route selection unit selects a candidate route satisfying a required delay requirement from the plurality of candidate routes on the basis of the estimated transmission time.

4. The optical path design device according to claim 1, further comprising:
a route evaluation unit which determines a route for uniformizing a utilization rate of a wavelength from the plurality of candidate routes selected by the route selection unit on the basis of information indicating a utilization situation of the wavelength of each route.

5. The optical path design device according to claim 1, further comprising:
a route calculation unit which derives a plurality of candidate routes on the basis of information indicating a positional relationship of the optical transmission network and information indicating a request condition of an optical path,
wherein the transmission quality calculation unit estimates the transmission quality of the plurality of candidate routes derived by the route calculation unit.

6. An optical path design method executed by a computer, the method comprising:
estimating transmission quality of a plurality of candidate routes in an optical transmission network; and
selecting a candidate route satisfying the transmission quality from the plurality of candidate routes.

7. (canceled)

8. The optical path design method of claim 6, the method comprising:
selecting a candidate route transmitted with respect to a route length of each candidate route included in the plurality of candidate routes on the basis of information indicating a modulation mode that is usable by a device constituting the optical transmission network.

9. The optical path design method of claim 6, the method comprising:
estimating transmission times of the plurality of candidate routes, and
selecting a candidate route satisfying a required delay requirement from the plurality of candidate routes based on the estimated transmission time.

10. The optical path design method of claim 6, the method comprising:
determining a route for uniformizing a utilization rate of a wavelength from the plurality of candidate routes selected based on information indicating a utilization situation of the wavelength of each route.

11. The optical path design method of claim 6, the method comprising:
deriving a plurality of candidate routes based on information indicating a positional relationship of the optical transmission network and information indicating a request condition of an optical path,
wherein the transmission quality of the plurality of candidate routes is estimated and derived.

12. The optical path design device according to claim 1, wherein the route selection unit determines a candidate route based on the transmission distance of the route and the transmission quality value stored in a transmission quality database.

13. The optical path design device according to claim 4, wherein the route evaluation unit evaluates the determined candidate routes and selects one route or prioritize the candidate routes.

14. An optical path design system comprising:
at least one processor; and
memory storing instructions that, when executed by the at least one processor, causes the system to perform a set of operations, the set of operations comprising:
estimating transmission quality of a plurality of candidate routes in an optical transmission network; and
selecting a candidate route that satisfies the transmission quality from the plurality of candidate routes.

15. The optical path design system of claim 14, further comprising:
selecting one candidate route from candidate route information; and
determining a transmittable modulation mode based on length of the selected candidate route.

16. The optical path design system of claim 15, further comprising:
determining the modulation mode capable of transmitting the selected candidate route; and
the selected candidate route information is deleted from a candidate route information database when there is no modulation mode that allows transmission of the selected candidate route is identified.

17. The optical path design system of claim 15, further comprising:
determining whether the selected candidate route satisfies transmission quality corresponding to delay requirement of the optical path and the modulation mode; and
the selected candidate route information is deleted when the selected candidate route does not satisfy the optical path delay and the modulation mode.

18. The optical path design system of claim 15, further comprising:
determining a bit rate of the selected modulation mode and number of optical paths for each selected candidate route; and
deriving a number of carriers based on the determined bit rate.

19. The optical path design system of claim 15, further comprising:
deriving allocation wavelength for each selected candidate route;
compares maximum wavelength number among one or more wavelength numbers assigned to each selected candidate route; and
determines the candidate route having a smallest wavelength number.

20. The optical path design system of claim 15, wherein output of the selected candidate route indicates a best route based on the transmission quality of the optical path.
